(19) United States
(12) Patent Application Publication
(10) Pub. No.: US 2016/0198278 A1
(43) Pub. Date: Jul. 7, 2016

(54) SYSTEM AND METHOD FOR AUDIO SIGNAL CLIP DETECTION AND INDICATION

(71) Applicant: AudioControl, Inc., Mountlake Terrace, WA (US)

(72) Inventor: ROBERT MICHAEL RIGGS, LYNNWOOD, WA (US)

(21) Appl. No.: 14/589,654

(22) Filed: Jan. 5, 2015

(51) Int. Cl. H04R 29/00

(52) U.S. Cl. CPC H04R 29/008

(57) ABSTRACT

Systems and methods for audio waveform clipping detection and indication are described herein. For example, an audio waveform clipping detection and indication system may include a first comparator, a second comparator, a timer, and an indicator. The first comparator may determine if an audio signal is present, the second comparator may determine if a slope of the audio signal is a shallow slope, and the timer may at least determine if the slope of the audio signal is a shallow slope for a threshold amount of time. An indication of clipping may be provided by an indicator based on outputs of the first and second comparators and the timer. The indication may provide feedback of audio waveform clipping.

### BACKGROUND

Audio systems, whether they are for home or vehicle, may desirably be tuned to reduce noise and improve overall sound quality. Various factors may affect the sound quality, such as gain settings, distortion due to signal quality, power supply noise, etc. Audio installers may at least take these factors into consideration when installing and optimizing an audio system. The audio system may include components, such as amplifiers, equalizers, and head units, and each component may be adjusted individually so that the sound quality provided by the system is of optimal quality.

To optimize an audio system, each component in an audio system may be tuned, setting the gain for example, so that each component produces their maximum output at nearly the same time. The gain of each component may be set so that the maximum level occurs in a linear part of a gain curve. Reaching or exceeding the power supply level may not be desirable since doing so may degrade noise quality. Yet, it may be difficult to know the output level of each component relative to its own power supply levels. Thus, it may be desirable to know the signal level output by a component so that the component's gain may be adjusted to stay within the linear part of the gain curve and to reduce noise, which may improve sound quality of the audio system.

### BRIEF DESCRIPTION OF THE DRAWINGS

FIG. 1 is a block diagram of an audio system according to an embodiment of the present disclosure.

FIG. 2 is a block diagram of a clipping indication system according to an embodiment of the present disclosure.

FIG. 3 is an illustrative example of a clipping detection and indication circuit according to an embodiment of the present disclosure.

FIG. 4 is an example audio waveform chart illustrating input audio waveforms and clipping detection according to an embodiment of the present disclosure.

### DETAILED DESCRIPTION

Embodiments of the present disclosure provide systems and methods for audio waveform clipping detection and indication. For example, a circuit may detect the presence of an audio signal, determine whether the signal displays clipping characteristics, and indicate the presence of clipping when detected. The presence of clipping may provide feedback for installing or adjusting an audio system. Certain details are set forth below to provide a sufficient understanding of embodiments of the invention. However, it will be clear to one skilled in the art that embodiments of the invention may be practiced without these particular details. Moreover, the particular embodiments of the present invention described herein are provided by way of example and should not be used to limit the scope of the invention to these particular embodiments.

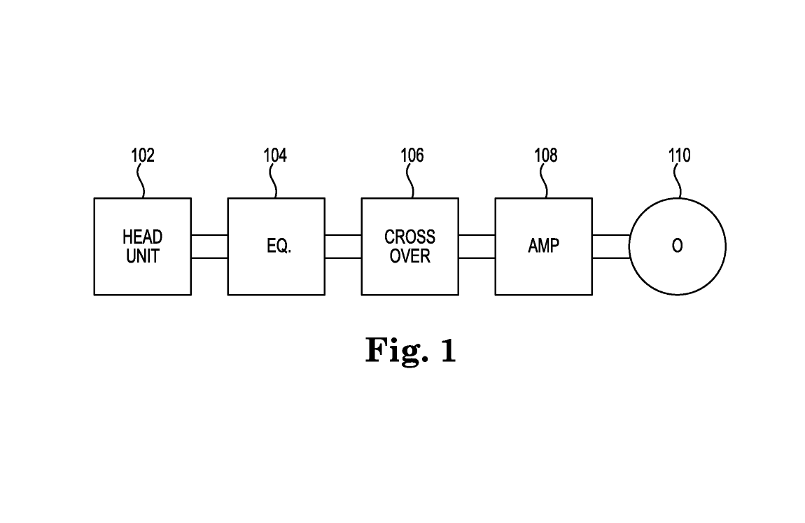

FIG. 1 illustrates an audio system 100 according to the present disclosure. The audio system 100 may include, but is not so limited to, a head unit 102, an equalizer 104, a crossover 106, an amplifier 108, and a speaker 110. The audio system 100 may either be a car audio system or a home audio system, for example. The head unit 102 may either be a component of car audio system, such as a main stereo component, or a component of a home audio system, such as a receiver and/or a tuner. In the audio system 100, a subsequent component may be described as being downstream from the prior component and the prior component may be described as being upstream from the subsequent component. For example, the equalizer 104 is downstream from the head unit 102, as are the crossover 106, amplifier 108 and speaker 110. The head unit 102 is upstream from the equalizer 104, as well as upstream of the crossover 106, amplifier 108 and speaker 110. The illustrative audio system 100 may represent any standard or non-standard audio system. The audio system 100 may, for example, be used to listen to audio included on any audio storage medium such as a compact disc, digital audio file, vinyl album, cassette tape, or eight-track, which may be read by or received by the head unit 102. The head unit 102 may provide the audio signals, e.g., audio waveforms, to the components downstream in the audio system so that the audio is eventually reproduced by the speaker 110 for listening. The audio waveform may propagate through the audio system 100 in either left and right signals, as one skilled in the art would understand, as a single audio waveform, or combinations thereof

The intervening components between the head unit 102 and the speaker 110, such as the equalizer 104, crossover 106, and amplifier 108 may be optional. In audio systems that include an equalizer 104, crossover 106, and/or amplifier 108, the components may condition the audio signal based on desired sound characteristics of a user of the audio system 100. For example, the equalizer 104 may allow for the audio signal to be conditioned differently for each of a plurality of frequencies, where conditioning implies adjusting the filter response for each of the plurality of frequencies. The crossover 106 may split the audio signal into separate frequency bands for routing to speakers optimized for each of those frequency bands. The output of the crossover 106 may then be provided to the amplifier 108 for amplification before driving the speaker 110. Although only one amplifier and speaker is depicted in FIG. 1, the crossover may provide separate outputs for each frequency band, and each frequency band may include a respective subsequent amplifier and speaker. Additionally, components of the audio system 100 may include their own adjustable gain. The gain of each component may be adjusted to tune their respective outputs with regards to their respective power supply levels and overall desired loudness, for example.

During installation and tuning of an audio system, such as the audio system 100, the respective gain of each component may need to be adjusted to reduce noise within the system and to provide quality sound output. Regardless of whether the audio system includes the components of the embodiment illustrated in FIG. 1 or is a simpler system that may only include a head unit, amplifier, and speaker, adjusting the gain of each component to the linear part of their respective gain curve may improve sound quality of not only that component but also of the overall audio system. The sound quality of the audio system 100 may further be improved if each component reaches their maximum output substantially concurrently. If the gain of any one component is adjusted too high, however, the output waveform of that specific component may run out of headroom, which means that the level of the output waveform has exceeded the level of that component's power supply. In such a situation, clipping of the output waveform may occur. Clipping means that the output waveform is abruptly cut off at a maximum level corresponding to the level of the power supply, which may occur at both positive and negative levels of the power supply. Clipping, unfortunately, may add noise to the audio waveform and it may be desirable to avoid clipping to maintain a desired sound quality.

One technique to aid in adjusting the gain of each component so to avoid clipping, but also to provide maximum gain, may be to determine when an output of an upstream component begins to display clipping. The determination may be made by a downstream component. Based on the clipping, the gain of the upstream component may be reduced to prevent the clipping. To make this determination, a clipping detection and indication system 112 may be included in the audio system 100. In the embodiment illustrated in FIG. 100, the clipping detection and indication system 112 may be included in one or more of the components of the audio system 100, for example. The clipping detection and indication system 112 is depicted at an input of the components in FIG. 1, but may alternatively be located at an output of a component. The clipping detection and indication system 112, however, may also be a separate component coupled to the audio system 100, rather than included in a component of the audio system 100. The clipping detection and indication system 112 may be coupled to an input of a component to evaluate the input audio signal received from upstream. The clipping detection and indication system 112 of the crossover 106 may, for example, indicate the presence of clipping in the output provided by the equalizer 104 and/or head unit 102. Based on the clipping indication, the gain of the equalizer 104 and/or head unit 102 may be reduced until the clipping detection and indication system 112 included ceases to indicate the presence of clipping in the received audio waveform.

In an embodiment where the clipping detection and indication system 112 is provided as a separate component, the separate component may be coupled to an output of an audio component to detect the presence of clipping. For example, an installer installing an audio system may couple the separate component to the output of the head unit 102 to test for clipping. If clipping is indicated, then the gain of the head unit may be adjusted down until clipping is no longer indicated.

Conventional clipping detection methods may require knowledge of the power levels of the component in order to determine whether clipping is present. The clipping detection and indication system 112, however, may determine the presence of clipping without knowledge of the power level of the component providing the audio waveform. Based on the example above, the clipping detection and indication system 112 of the crossover 106 may detect clipping in the audio waveform provided by the equalizer 104 without knowledge of the internal power levels the equalizer 104 operates. As indicated in the audio system 100, intervening components between the head unit 102 and the speaker 110 may include a clipping detection and indication system 112, but this depiction is non-limiting. If, for example, the head unit 102 receives a signal from a pre-amplifier (not shown), the head unit 102 may include a clipping detection and indication system 112 to indicate the presence of clipping for the pre-amplifier. This flexibility may allow installation of an audio system based simply on an audio signal generated by the head unit 102 and does not require additional knowledge regarding the various power levels associated with the components of the system.

The clipping detection and indication system 112 may indicate the presence of clipping based on various conditions being satisfied. A first condition may simply be the presence of a valid input waveform, which may be determined based on one or more reference voltages. A valid input waveform may be a waveform that provides measurable audio and is not simply random noise and/or spurious waveforms propagating through the audio system 100, for example. A second condition may be a slope of the input waveform, for example, having a shallow slope. A determination of whether or not a waveform displays a shallow slope may be made by comparing a voltage indicative of the slope to one or more reference voltages. As used herein, a shallow slope may be a slope that is nearly zero. As such, the slope reference window may be very narrow so that slopes of slow changing audio waveforms are not detected as shallow. If these two conditions are met, then clipping may be present based on satisfaction of a third condition. The third condition may include determining whether both conditions one and two are satisfied for a threshold period of time, or whether at least condition two is satisfied for the threshold period of time. Based on the satisfaction of all three conditions, the presence of clipping may be indicated. An indicator may be a visual signal, e.g., an activated light emitting diode (LED), or it may be a feedback signal provided to the upstream component providing the clipped audio waveform. The upstream component, for example, may lower its respective gain until the feedback signal ceases to indicate the presence of clipping.

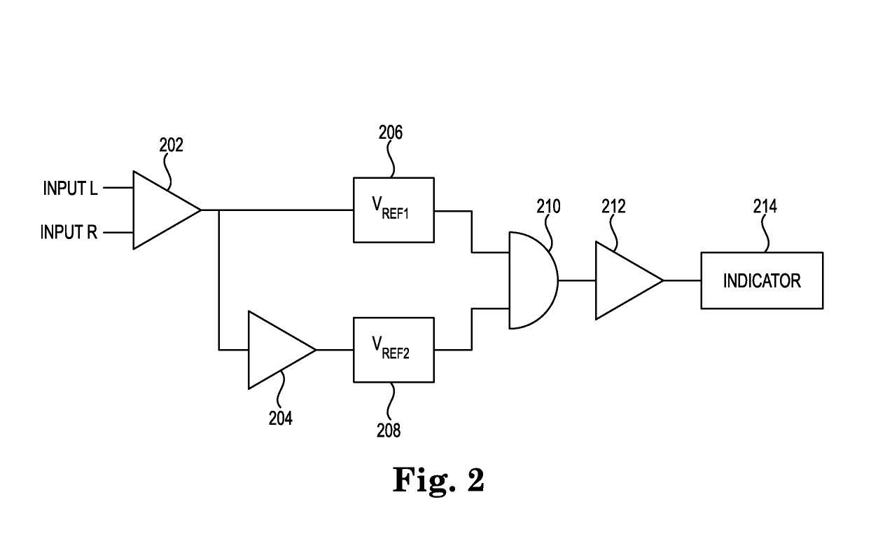

FIG. 2 is a block diagram of an example clipping detection and indication system 200 according to the present disclosure. The system 200 may be used for the clipping detection and indication system 112 of FIG. 1, for example. Alternatively, the system 200 may be a standalone component an installer may use to tune components of an audio system during installation. A standalone component may include an internal power source, batteries for example, and controls for enabling the component. The standalone component may be a handheld device that may couple to an audio component and provide indication of whether an output of the component presents clipping.

The system 200 may include two signal paths, with first and second signal paths configured to determine if the first and second conditions have been satisfied, respectively. If both conditions are simultaneously satisfied, and satisfied for a threshold amount of time (e.g., satisfying the third condition), an indicator 214 may be activated. Based on the activation of the indicator 214, an installer setting up an audio system of components may be alerted to reduce the gain of a component providing the clipped audio waveform.

The system 200 may further include a buffer 202, a differentiator 204, a first comparator 206, a second comparator 208, an AND gate 210, and a timer 212. The buffer 202 may receive the left and right inputs of an audio waveform and may be configured to sum the two inputs. The buffer 202 may then provide a composite audio waveform to the first and second signal paths.

The first signal path may include the first comparator 206, which may be configured to determine whether or not a valid audio waveform is present on the inputs of the buffer 202. The first comparator 206 may make this determination by comparing various voltage levels of the composite audio waveform to the first reference voltage Vref1. The first reference voltage Vref1 may be a voltage threshold or it may define a first reference window. Thus, the first comparator 206 may determine if peak voltages of the composite audio waveform is greater than Vref1. Alternatively, the comparator 206 may be a window comparator configured to determine whether the composite audio waveform is within or outside of the first reference window as defined by Vref1, e.g., whether voltage levels of the composite audio waveform are outside of a voltage window defined from −Vref1 to +Vref1. Alternatively, the comparator 206 may be configured to determine if an absolute value of the composite audio waveform is greater than the first reference voltage. Based on the determination, the comparator 206 may indicate whether a valid composite audio waveform is present.

The second signal path may include the differentiator 204 and the second comparator 208. The differentiator 204 may be configured to determine a slope of the composite audio waveform and provide a signal indicative of the slope of the composite audio waveform to the second comparator 208. The second comparator 208 may be configured to determine whether or not the slope of the input waveform as provided by the differentiator 204 is shallow. The second comparator 208 may make this determination by comparing various voltage levels of the signal indicative of the slope of the composite audio waveform to the second reference voltage Vref2. For example, the second comparator 208 may determine if voltages of the signal indicative of the slope of the composite audio waveform are less than Vref2. Like the first reference voltage, the second reference voltage may be a voltage threshold or it may define a second reference window from −Vref2 to +Vref2. The second comparator 208 may be a window comparator, for example, which may be configured to determine if various voltage levels of the signal indicative of the slope of the composite audio waveform are within the second reference window. Alternatively, the second comparator may be configured to determine if an absolute value of various voltage levels of the signal indicative of the slope of the composite audio waveform are less than the second reference voltage Vref2. In some embodiments, the second reference window may be smaller than the first window reference. The second window comparator may also provide an output to the AND gate 210.

The AND gate 210 may receive the outputs of the first and second comparators and may provide an output to the timer 212, which may in turn activate the indicator 214. The indicator 214 may provide a visual alert and/or a feedback signal, for example.

In operation, the buffer 202 may receive the left and right signals of an audio waveform, sum the two signals, and provide a composite audio waveform to the first comparator 206 and the differentiator 204. The first comparator 206 may determine if a first condition is satisfied, e.g., whether a valid audio waveform is present on the inputs of the buffer 202. For example, the first comparator 206 may determine if the composite audio waveform is within the first reference window, e.g., whether the value of the summed signal is greater than the positive reference boundary +Vref1 and/or less than the negative reference boundary −Vref1. In turn, the first comparator 206 may provide a signal indicative of whether the composite audio waveform is within or outside of the first reference window to the AND gate 210 in response. For example, a relatively high level signal may represent that the composite audio waveform is greater than the reference voltage and a relatively low level signal may represent that the composite audio waveform is less than the reference voltage.

The differentiator 204 may receive the composite audio waveform from the buffer 202, generate a signal indicative of the slope of the composite audio waveform, and provide the signal indicative of the slope to the second comparator 208. The second comparator 208 may then determine whether the second condition is satisfied, e.g., whether the slope is shallow. For example, the second window comparator 208 may determine whether the slope is within the second reference window, e.g., whether the absolute value of the slope is less than the second reference voltage. If the slope does satisfy this condition, e.g., within the window defined by the second reference voltage, then a signal indicating so may be provided to the AND gate 210. A signal indicating the second condition is satisfied may be a high value, for example, and a signal indicating the second condition is not satisfied may be a low value.

If the AND gate 210 simultaneously receives high signals from the first and second comparators or at least overlapping, then an output of the AND gate 210 may be asserted high. The output of the AND gate 210 may then be provided to the timer 212. The timer 212 may be configured to determine whether the output of the AND gate 210 satisfies the third condition, e.g., is asserted high at least for a threshold amount of time. The threshold amount of time, for example, may be about 1 millisecond in some embodiments. Based on the timer 212 determining that that the third condition is satisfied, the timer 212 may activate the indicator 222.

Alternatively, the timer 212 may be coupled between the second window comparator 208 and the AND gate 210. In this arrangement, the timer 212 may determine whether the slope of the audio waveform is shallow, e.g., within the window established by the second reference voltage, for the threshold amount of time. When the slope of the audio waveform is shallow for the threshold amount of time, then timer 212 may provide a signal to the AND gate 210 indicating such, which in turn may activate the indicator 222.

The clipping detection and indication system 200 may provide indication of clipping based on an input waveform satisfying the three conditions—(1) valid audio signal, (2) shallow slope, and (3) the slope remaining shallow for the threshold amount of time. The indicator may then alert a user or the component providing the waveform of the presence of clipping. The detection of the clipping by the clipping detection and indication system 200 does not require knowledge of the power supply levels of a component providing the left and right audio waveform signals.

The first condition may be included in the clipping detection and indication system 200 because the slope of an invalid signal may always be shallow, such that the second condition would always be satisfied. Thus, the first condition ensures a valid signal is present. Additionally, the first reference voltage may be set at a level to indicate an audio waveform, but also to filter out random noise, which may be mistaken as a valid waveform if the first reference voltage is set too low.

Satisfaction of the second condition may be affected by the value of the second reference voltage. For example, the second reference voltage may be chosen to be small so not to indicate a shallow slope when the slope is not near zero. If the second reference voltage is set to high, then the second condition may be satisfied at positive/negative transition points of the audio waveform, which may be a false indication. These transition points and areas of vertical slope that would satisfy the second condition may be further filtered out by the time threshold. A short time threshold may be satisfied by the transition points or the vertical slope areas of the audio waveform. Thus, a longer threshold amount of time may filter out such areas.

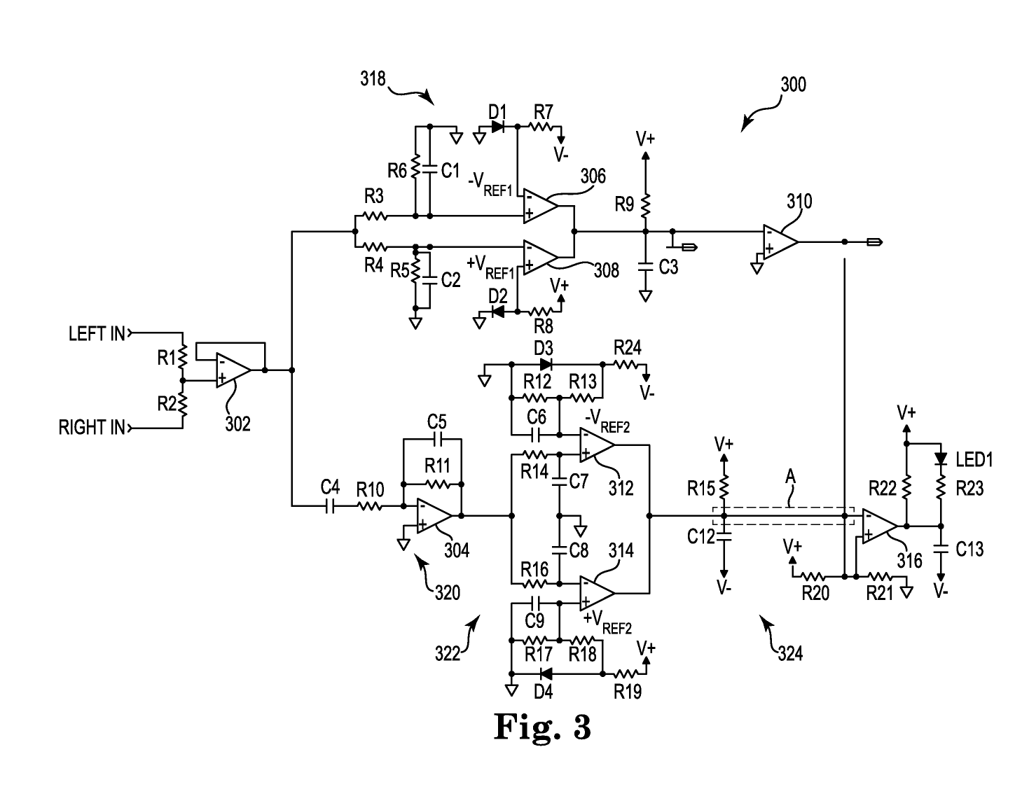

FIG. 3 is an example circuit 300 implementing a clipping detection and indication system according to the present disclosure. The circuit 300 may be used as the clipping and detection system 112 of FIG. 1 and/or the clipping detection and indication system 200 of FIG. 2. The circuit 300 is a non-limiting implementation of the clipping detection and indication systems 112 and 200, and one skilled in the art would recognize available variations to the illustrative circuit, all of which fall within the scope of the present disclosure. The circuit 300 may detect the presence of clipping on an input waveform received from an upstream component (not shown), such as a head unit for example, and provide indication of the presence of clipping upon detection. The indicator may be a visual alert, for example, that may allow an installer to adjust the gain of the upstream component, or the indication may be feedback provided to the upstream component.

The circuit 300 may include an input buffer 302, which is configured to sum left and right signals of an input waveform. The input buffer 302 may receive the left and right signals through resistors R1 and R2, respectively, at a first input. A second input of the input buffer 302 may be coupled to an output. In this manner, the input buffer 302 may be configured as a summing amplifier so that the left and right signals are summed. The output of the input buffer 302 may be the audio waveform of the summed left and right signals. The input buffer 302 may provide the output to two parallel signal paths. The first signal path may include a first window comparator 318 and an inverter 310, while the second path includes a differentiator 320, a second window comparator 322, and a timer 324. The outputs of the first and second paths may be provided to node A, which may be an input to a comparator 316. An output of the comparator 316 may activate an indicator, such as the light emitting diode LED1.

Because the first signal path includes a window comparator, the first signal path may be divided into two for providing two similar inputs to the first window comparator 318. The divide first signal path may include two input resistors R3 and R4. The two input resistors may be used to reduce the voltage of the audio waveform, and may be implementation specific due to the comparators used in fabricating the circuit 300. The input resistors R3 and R4 are non-limiting aspects of the present disclosure, and may optionally be omitted. Two resistor-capacitor (RC) circuits, such as the RC circuits defined by R6 and C1, and R5 and C2, may also be coupled to the divided first signal path. The two RC circuits may be configured as low pass filters to filter out power supply noise and pass signals in the audio band to the inputs of the firs window comparator 318. The low pass filters, for example, may be configured to filter out frequencies above 33 kHz.

The first window comparator 318 may include two comparators 306 and 308. Voltage divider circuits may be coupled to the two comparators 306 and 308 to provide the reference voltages for defining a first reference window for the first window comparator 318. The first reference window may range from −Vref1 to +Vref1. The absolute value of Vref1 may be 0.7 volts, for example, such that a firs reference window may range from -0.7 volts to +0.7 volts. The voltage divider circuits may mirror one another to provide a symmetrical window around zero volts, for example, and they may include a diode and a resistor. To define the negative boundary of the first reference window, an anode of the diode D1 is coupled to ground and a cathode of D1 is coupled to the negative input of the comparator 306 and also to one side of a resistor R7. The other side of the resistor R7 may be coupled to the negative rail of a power supply source. The combination of diode D1 and resistor R7 may determine the reference voltage -Vref1. The positive boundary of the first voltage reference window, +Vref1, may be determined by the voltage divider coupled to the positive input of the comparator 308. The +Vref1-defining voltage divider may include the diode D2 and the resistor R8 as shown in FIG. 3. A cathode of D2 may be coupled to ground and an anode of D2 may be coupled to the positive input of the comparator 308 and one side of the resistor R8, which may be coupled to the positive rail of the power supply source. As such, the first window comparator 318 may be configured to determine if an audio waveform is inside or outside of the first reference window. Whether or not the audio waveform is inside or outside of the first reference window may be the first condition, as discussed above. The first condition may be satisfied, for example, by an audio waveform being outside of the first reference window, e.g., by an absolute value of the audio waveform being greater than Vref1.

Outputs of the comparators 306 and 308 may be coupled together and further coupled to a negative input of a comparator 310. A positive input of the comparator 310 may be coupled to ground. Connecting the comparator 310 as described may result in the comparator 310 being configured as an inverter. The inclusion of an inverter in the first path may be implementation specific due to the outputs of the comparators 306 and 308, which change based on whether an input is within or outside of the first reference window. An output of the comparator 310 may be coupled to node A.

A differentiator 320 may be coupled to the output of the input buffer 302 and configured to determine a slope of the audio waveform. The differentiator 320 may include an input capacitor C4 coupled in series with an input resistor R10, which may be coupled to a negative input of an operational amplifier 304. A positive input of the operational amplifier 304 may be coupled to ground. Feedback may be provided from an output of the operational amplifier 304 to the negative input. The feedback may be provided through capacitor C5 and resistor R11, which may be parallel-coupled. The differentiator 320 may be a standard differentiator as one skilled in the art would know and understand. An output of the differentiator may be a waveform indicative of a slope of the audio waveform.

The output of the differentiator 320 may be coupled to an input of the second window comparator 322, which may be configured to determine if the audio waveform satisfies the second condition, as discussed above. The second condition may be satisfied when the waveform provided by the differentiator 320 is within a second reference window, for example. Like the first window comparator 318, the input to the second window comparator 322 may also be divided. The second window comparator 322 may include comparators 312 and 314 along with various other discrete components configured as voltage dividers to determine the second reference window and as low pass filters. The second voltage reference window may range from −Vref2 and +Vref2, and the second voltage reference window may be smaller than the first voltage reference window. The absolute value of Vref2 may be 0.07 volts, for example, such that the second reference window ranges from −0.07 volts to +0.07 volts. Because the second window comparator is configured to determine if the input waveform contains areas of shallow slope, e.g., flat areas that may indicate clipping, it may be desirable to have the second voltage reference window very tight to filter out slopes that may be shallow, but not necessarily flat.

Mirror voltage dividers are coupled to the negative and positive inputs of the comparators 312 and 314, respectively, to provide the negative and positive boundaries of the second reference window. The voltage divider coupled to the negative input of comparator 312 may determine the negative boundary of the second voltage reference window, e.g., −Vref2. The positive boundary, +Vref2, of the second voltage reference window may be determined by a voltage divider coupled to the positive input of the comparator 314. The voltage dividers may mirror one another so to define a symmetrical comparator window around zero voltage. The voltage dividers may include similar discrete components but may be complementary coupled so to provide a positive and negative voltage reference.

For example, the voltage divider that provides −Vref2 to the comparator 312 may include a diode D3 coupled between ground and a resistor R24, which may be coupled to the negative rail of the power supply. The diode D3 may be coupled in parallel with two series-coupled resistors R12 and R13. The node that connects R12 and R13 may be coupled to the negative input of the comparator 312. Further, a capacitor C6 may be coupled in parallel with R12 and the negative input of the comparator 312. The voltage divider that provides +Vref2 to the positive input of the comparator 314 may include similar discrete components, but with a diode D4 coupled complementary between ground and a resistor R19, which is coupled to the positive rail of the power supply.

The inputs of the comparators 312 and 314 that receive the output of the differentiator 320 may include low pass filters configured to filter power supply noise and allow audio band frequencies to pass. For example, a resistor R14 and a capacitor C7 may define a low pass filter coupled to the positive input of the comparator 312. Similarly, a resistor R16 and a capacitor C8 may define a low pass filter coupled to the negative input of the comparator 314.

The outputs of the comparators 312 and 314 may be coupled together and coupled to node A. Also coupled to node A may be a timer 324. The timer 324 may include a resistor R15 and a capacitor C12. The resistor R15 may be coupled between the positive rail of the power supply and node A, with the capacitor C12 coupled between node A and the negative rail of the power supply. A time constant defined by the resistor R15 and the capacitor C12 may define the threshold amount of time a slope of the input waveform may need to remain shallow to detect the presence of clipping. The timer 324 may be configured to determine if the third condition is satisfied, e.g., whether at least condition two is satisfied for a threshold amount of time.

The timer 324, the output of the comparator 310, the output of the second window comparator 322, and an input of the comparator 316 may be coupled to node A. The other input of the comparator 316 may be coupled to a voltage divider defined by resistors R20 and R21. The resistors R20 and 21 may be coupled in series between the positive rail of the voltage supply and ground and a node connecting the two resistors may be coupled to the positive input of the comparator 316. If the resistors R20 and R21 are of equal resistance then a reference voltage of one-half the positive power supply may be provided to the comparator 316.

An output of the comparator 316 may drive the light emitting diode LED 1. Also coupled to the output of the comparator 316 may be a capacitor C13, resistor R22 and resistor R23. An RC time constant as defined by C13 and R22 may determine a rate at which the LED1 blinks, which is optional.

In operation, a left and right signal of an input waveform may be provided separately to the input buffer 302. The input buffer 302, in turn, may sum the left and right signals and provide an audio waveform to the first and second signal paths of the clipping detection and indication circuit 300. The first signal path may be configured to determine whether the first condition is satisfied, e.g., whether a valid audio signal is present on the inputs of the input buffer 302. The first condition may be satisfied, for example, when the audio waveform includes values outside of the first reference window, for example, such that voltage values of the audio waveform are greater than +/−Vref1. The presence of a valid audio signal may be determined by the first window comparator 318. An audio waveform that stays inside of the first reference window, e.g., voltages between +and −Vref1, may indicate noise, for example. The first window comparator 318 may indicate an input falling within the first reference window by pulling the outputs of the comparators 306 and 308 low, whereas an input falling outside of the window may be indicated when the outputs of the comparators are put into a high impedance state.

To indicate that the first condition is satisfied, e.g., that the audio waveform is outside of the first reference window, the comparator 310 may be configured to put its output into a high impedance state when the output of the first window comparator is pulled low. Pulling them output of the first window comparator 318 may prevent a capacitor C3 from charging, which may cause the output of the comparator 310 to be pulled low. Conversely, putting the output of the first window comparator 318 into a high impedance state may cause current to flow through resistor R9, charging capacitor C3, which in turn generates a positive voltage on the input of the comparator 310. In this case, the output of the comparator 310 may be put into a high impedance state. The output of the comparator 310 in the high impedance state may indicate that the first condition has been satisfied.

In parallel, the differentiator 320 may generate an output indicative of the slope of the audio waveform and provide a waveform indicative of the slope to the second window comparator 322. The second window comparator may be configured to determine if a slope of the audio waveform is shallow, e.g., within the second reference window. Based on the voltage falling within the second reference window, the outputs of the comparators 312 and 314 may be put into a high impedance state. During times when the slope of the audio waveform is outside of the second reference window, the outputs of the comparators 312 and 314 may be pulled low, which may prevent the timer 324 from operating, e.g., being activated. During times when the slope of the audio waveform is inside of the second reference window, the outputs of the comparators 312 and 314 may be put into the high impedance state, which may allow the timer 324 to be activated, depending also on the output state of the comparator 310.

Thus, to determine whether or not the third condition has been satisfied, the outputs of the comparators 310, 312, and 314 may all need to be in the high impedance state. When all three outputs are in the high impedance state, the timer 324 may be activated. When these outputs are in the high impedance state, the capacitor C12 may begin to charge from current drawn through resistor R15. As the voltage on node A increases above the reference voltage on the positive input of the comparator 316, the LED 1 may be activated. Activating LED 1 may indicate the presence of clipping on the audio waveform. As such, the output of the comparator 316 may be grounded causing current to flow through the LED 1 and resistor R23. The RC time constant defined by resistor R22 and capacitor C13 may define a rate at which the LED1 blinks. A blinking LED1 may indicate the presence of clipping on the input waveform.

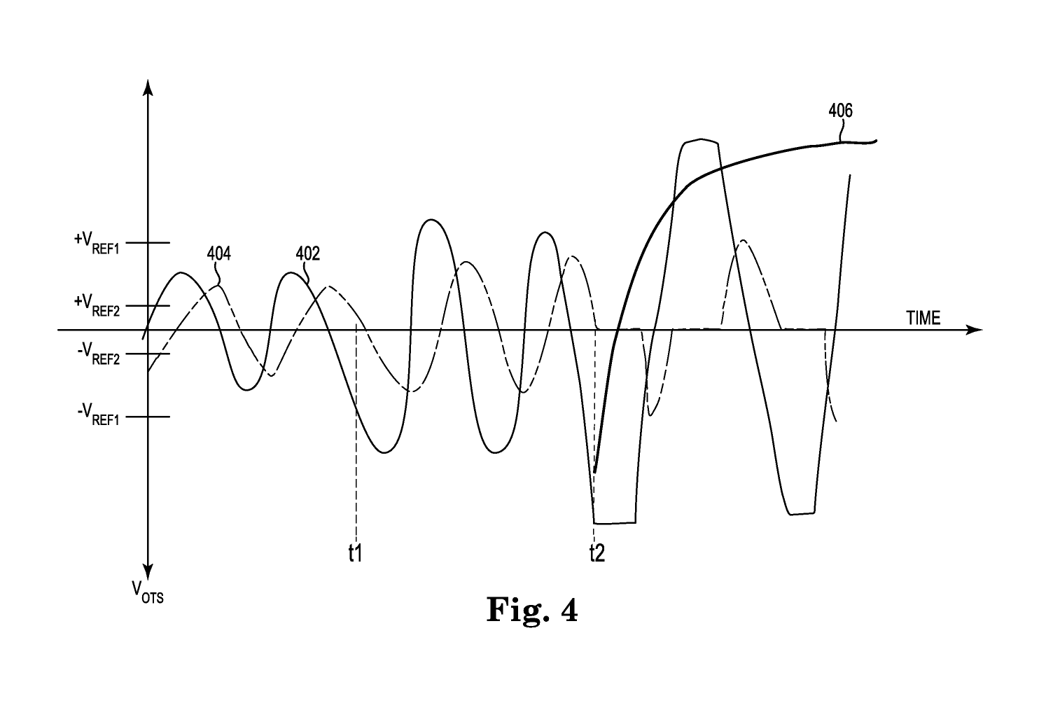

FIG. 4 is an example audio waveform chart 400 illustrating input audio waveforms and clipping detection in accordance with the present disclosure. The chart 400 may depict an input audio waveform in three different conditions. Condition one representing an invalid input, condition two representing a valid input that does not display any clipping, and condition thee representing a valid input that displays clipping. The chart 400 includes an input waveform 402, a slope waveform 404, and a clipping indication waveform 406. The three waveforms may be used to further illustrate the operation of the clipping detection and indication systems/circuit described above.

An audio input, represented by the input waveform 402, may be an example audio waveform after the left and right signals have been summed. The waveform 402 may change over time, as audio waveforms are likely to do. The input waveform 402 may be an input to a first window comparator and a differentiator. An output of the differentiator may be represented by the slope waveform 404, which may indicate the slope of the input waveform 402 as it changes. The clipping indication waveform 406 may indicate the presence of clipping of the input waveform 402.

In a first time region between zero and time t11, the input waveform falls within the Vref1 window. As such, no valid audio signal is present. While the input waveform 402 may display shallow slope at times within this region, an output signal may not indicate clipping since the input waveform is deemed to not satisfy the first condition.

In a second time region between time t1 and time t2, the input audio waveform 402 may be valid since it includes portions that are outside of the Vref1 window. The slope waveform 404 in this time region, however, does not display any clipping of the input waveform 402, e.g., there are no areas of the slope waveform 404 that are within a second reference window, e.g., shallow. Thus, there is no occurrence of the clipping indication waveform 406.

In a third time region, defined only by a lower bound of time t2, the input waveform begins to display clipping at time t3. The slope waveform 404 indicates clipping by being flat, e.g., zero slope, from time t3 to time t4. This section of shallow slope, e.g., zero slope, may indicate clipping. Thus, in turn, the clipping indication waveform 406 begins to rise. The clipping indication waveform 406, as previously described, may be used to provide an indication of clipping.

From the foregoing it will be appreciated that, although specific embodiments of the invention have been described herein for purposes of illustration, various modifications may be made without deviating from the spirit and scope of the invention. Accordingly, the invention is not limited except as by the appended claims.

What is claimed is:

1. An apparatus, comprising:
a first comparator configured to determine if an audio signal is present;
a second comparator configured to determine if a slope of the audio signal is a shallow slope; and
a timer configured to at least determine if the slope of the audio signal is a shallow slope for a threshold amount of time.

2. The apparatus of claim 1, further comprising an indicator configured to provide an indication that the slope is a shallow slope for a threshold amount of time.

3. The apparatus of claim 2, wherein the indicator comprises a visual indicator.

4. The apparatus of claim 1, wherein the second comparator is configured to compare a voltage indicative of the slope of the audio signal to a first reference voltage.

5. The apparatus of claim 4, wherein the first comparator is configured to determine whether the audio signal is greater than a second reference voltage.

6. The apparatus of claim 4, further comprising a differentiator configured to provide the voltage indicative of the slope of the audio signal to the second comparator.

7. The apparatus of claim 1, further comprising a buffer configured to receive left and right inputs of the audio signal and sum the left and right inputs to provide a composite audio signal to the first and second comparators.

8. The apparatus of claim 1, further comprising: one or more amplifiers for amplifying the audio signal, and control configured to alter internal gain based on an input.

9. A method for determining clipping of an input waveform, the method comprising:
determining whether an audio signal is present;
determining whether a slope of the audio signal is shallow for a threshold amount of time; and
indicating clipping of the input waveform responsive to an audio signal being present and the slope of the audio signal being shallow for the threshold amount of time.

10. The method of claim 9, further comprising determining the slope of the audio signal.

11. The method of claim 9, wherein determining whether a slope of the audio signal is shallow for a threshold amount of time comprises determining whether a voltage indicative of the slope of the audio signal is less than a reference voltage for the threshold amount of time.

12. The method of claim 9, wherein determining whether an audio signal is present comprises determining whether the audio signal is greater than a reference voltage.

13. The method of claim 9, wherein indicating clipping of the input waveform responsive to an audio signal being present and the slope of the audio signal being shallow for the threshold amount of time comprises providing a visual indicator.

14. The method of claim 9, wherein determining a slope of the audio signal comprises determining whether a voltage indicative of the slope of the audio signal is within a voltage window.

15. An apparatus, comprising:
a first comparator configured to determine whether an input is greater than a first reference and further configured to provide a first output indicative of the input being greater than the first reference;
a second comparator coupled to the differentiator and configured to determine whether a voltage indicative of a slope of the input is less than a second reference voltage and provide a third output indicative of the voltage indicative of the slope of the input being less than the second reference voltage;
a timer coupled to the second comparator and configured to determine whether the voltage indicative of the slope of the input is less than the second reference voltage for a threshold amount of time; and
an indicator coupled to the timer and configured to indicate the presence of clipping in the input based at least on the timer determining that the voltage indicative of the slope of the input is less than a second reference voltage for a threshold amount of time.

16. The apparatus of claim 15, wherein the first comparator is a window comparator and the first comparator determines whether the input is greater than a first reference window defined by the first reference voltage.

17. The apparatus of claim 15, wherein the second comparator is a window comparator and the second comparator determines whether the voltage indicative of the slope of the input is less than a second reference window defined by the second reference.

18. The apparatus of claim 15, wherein the timer is activated based on outputs of the first and second comparators.

19. The apparatus of claim 15, wherein the first output indicative of the input being greater than the first threshold is a determination that the input is a valid audio signal.

20. The apparatus of claim 15, wherein the determination whether the voltage indicative of the slope of the input is less than a second threshold voltage for a threshold amount of time is indicative of the input clipping.

21. The apparatus of claim 15, further comprising:
a differentiator configured to determine a slope of the input and further provide the voltage indicative of the slope to the second comparator.

22. The apparatus of claim 15, wherein the indicator is configured to activate a visual indicator to indicate the presence of clipping in the input.
